(19) United States
(12) Patent Application Publication
(10) Pub. No.: US 2007/0028535 A1
(43) Pub. Date: Feb. 8, 2007

(54) Removable hurricane and security panels for doors and windows

(76) Inventor: Brian Pandorf, Clearwater, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/491,390

(22) Filed: Jul. 21, 2006

Related U.S. Application Data
(60) Provisional application No. 60/705,392, filed on Aug. 4, 2005.

(51) Int. Cl. E06B 3/26

(52) U.S. Cl. 52/202

(57) ABSTRACT

A panel and frame system with latches for easy installation to protect windows and doors, including sliding glass doors, in hurricanes and as a security measure for preventing unwanted intrusion of wind and personnel in the building.

### RELATED APPLICATION

This application claims the benefit of provisional application Ser. No. 60/705,392 filed Aug. 4, 2005.

### FIELD OF THE INVENTION

The invention relates to protection and security panel systems and braces for windows and doors.

### BACKGROUND OF THE INVENTION

There are several panel systems or bracing systems commercially available; however, many are heavy systems, others are very costly, others require a significant amount of time to install, and others require a multitude of anchor holes adversely affecting the house appearance. Those using plywood end up with the deterioration of the plywood during storage and a subsequent waste of money. What is needed is a system that can be installed in a matter of a few minutes.

### SUMMARY OF THE INVENTION

In one embodiment of the invention, a removable storm panel system is designed for interior or exterior use. The panel can be put in place inside or outside a building window. The main frame is mounted on the interior or exterior extension of the wall. The main frame is designed with a lip to seal all around the panel.

Each panel is preferably broke on all sides for adding rigidity and for sealing against wind intrusion. A plurality of latching levers secures the panel in place against the main frame inside channel. A stiffener acts as a stiffener for the panel interlock latches to secure each latch which gives full panel support to protect the window.

In another embodiment, a central latch lever is included as a main lever which is linked to each of the latches so that upon activation of the central mechanism, all or at least some multiple latches engage the frame member and seals the panel in the frame.

In another embodiment for sliding glass doors, other large door ways or for large windows, tubing or a longitudinal structural member with upper flanges for bolting into the building wall and a pin or barrel bolt type of mechanism for inserting a pin into a predrilled hole in the floor or ground surface is used. One such assembly is used on each side of the door and two panels are used where one side of each panel wraps around each opposing structural member and the other sides of the panels are secured together with bolts or sheet metal screws or similar fasteners. Intermediate panels may be used where each side is in turn fastened to the end panels. It is preferred that the panels have on or more cross breaks near the joining portions of the panels to add rigidity to the panels being joined. In some counties like Miami-Dade county, it may be required to include a stiffener, for example, a ¼ inch flat bar stiffener against the outwardly protruding break portion near the joined area of the panels. Typically, this may be required when using about a 1/16 inch thick aluminum panel, but it should be noted that it is only intended to minimize flexure at the joint area.

Another invention is a brace system for garage doors. The basic system is designed to have a bracket attached to the header of the door. The bracket has a latching hook design for catching and engaging an opposite shaped hook attached near the upper end of a vertical structural member such as a 2×6 or 2×4 framing member or a metal tubing form. At the lower end of the structural member is another bracket attached to the structural member incorporating a pin or barrel bolt system where the pin is insertable in a predrilled hole, preferably located behind the structural member. One system can be installed near the center of the garage door or two or three such systems may be installed spaced along the door. If desired to further limit any flexure of the garage door from the wind forces, one or more intermediate brackets can be installed on the structural member placed between the ends of the garage door where the intermediate bracket is attached on one end to the structural member and the opposite end of the intermediate bracket is configured to overlap the sides of one of the garage panel hinges and a pin is placed through an aperture on one side of the bracket, through the aperture in the hinge and through the aperture on the other side of the bracket. This intermediate bracing bracket should significantly reduce the flexure in the center of the garage door, if it is a concern to an end user.

In another embodiment, a storm panel is made to completely cover the outside of a window with perimeter attachments to wall anchoring fasteners on an exterior wall surrounding the window. The panel is shaped at its perimeter portion so as to have an angular portion. The angular portion has spaced-apart apertures through which the wall anchor fasteners extend for fastening with a wing nut or other female threaded nut. Because the base of the nut will tighten against the angular portion, most of the pressure is applied to the inside surface portion of the angular portion and the angular portion thereby acts as a spring locking washer, so separate washers are not needed to be handled while attempting to mount the storm panel. Handling both washers and nuts can become cumbersome when mounting panels, especially when the storm is approaching and winds are already being felt. The storm panel preferably has breaks in it to form a bowed X-shape on its exterior surface. The perimeter portion has a flatten portion exterior to the angular portion that is configured to rest against the surface of the exterior wall surrounding the window being covered.

Typical thickness of storm panels is about 1/16 inch thick, made from aluminum, stainless steel or galvanized steel. Certainly, as high strength composite materials are developed, such materials could also be used with the invention.

### BRIEF DESCRIPTION OF THE DRAWINGS

In the accompanying drawings:

FIG. 1 is a perspective conceptual view of one embodiment of the present invention with multiple latches in an engaged position with the panel frame;

FIG. 2 is a perspective conceptual view of the embodiment of FIG. 1 with multiple latches in unlatched position;

FIG. 3 a perspective conceptual view of the embodiment of FIG. 1 with the storm panel separated from the frame;

FIG. 4A is a cross-sectional plan view of the embodiment of FIG. 1;

FIG. 4B is a conceptual cross-section plan view depicting the invention mounted inside the window opening and on the outside of the building window;

FIG. 4C is a conceptual cross-section plan view depicting the invention mounted inside the window opening and on the interior side of the building window;

FIG. 5A is a conceptual depiction of one example of providing a common or central mechanism to simultaneously latch and unlatch multiple latches in position;

FIG. 5B is a depiction of the embodiment of FIG. 5A with the storm panel being separated from the frame;

FIG. 6A is a conceptual depiction of another example of providing a common or central mechanism to simultaneously latch and unlatch multiple latches in position;

FIG. 6B is a depiction of the embodiment of FIG. 6A with the storm panel being separated from the frame;

FIG. 6C is a depiction of the embodiment of FIG. 6A with the central control mechanism being on the opposite side of the storm panel latches for use in operating the latches from inside the house;

FIG. 7 is another example of the embodiment of FIG. 1 mounted so as to protect a shaped window (not viewable in depiction), in this case, a circular shaped window;

FIG. 8 is a depiction of the embodiment of FIG. 7 with the storm panel separated from the frame;

FIG. 9 is a perspective view of an example of another embodiment for sliding glass doors and large windows;

FIG. 10 is an exploded view of the depiction of FIG. 9;

FIG. 11 is a conceptual depiction of another embodiment designed to cover a window and any associated decorative moldings or trim around the windows;

FIG. 12 is a perspective view of the embodiment of FIG. 11 with the storm panel separated from the frame;

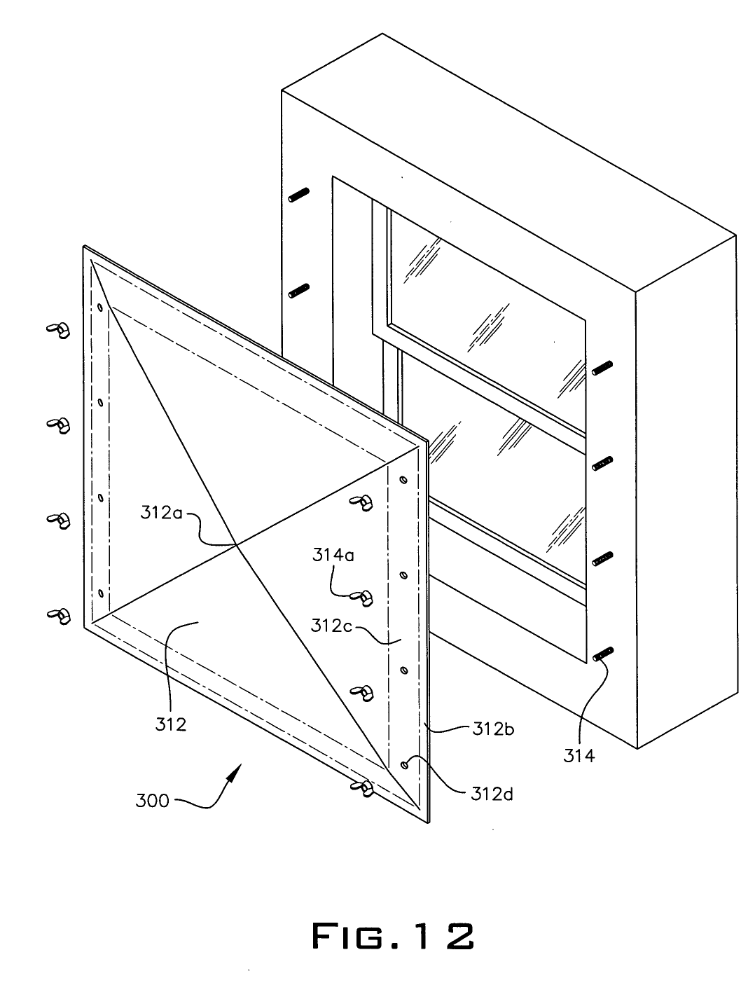

FIG. 13 is a cross-sectional plan view of the embodiment of FIG. 11, with the panel covering trim or molding around at least a portion of the window;

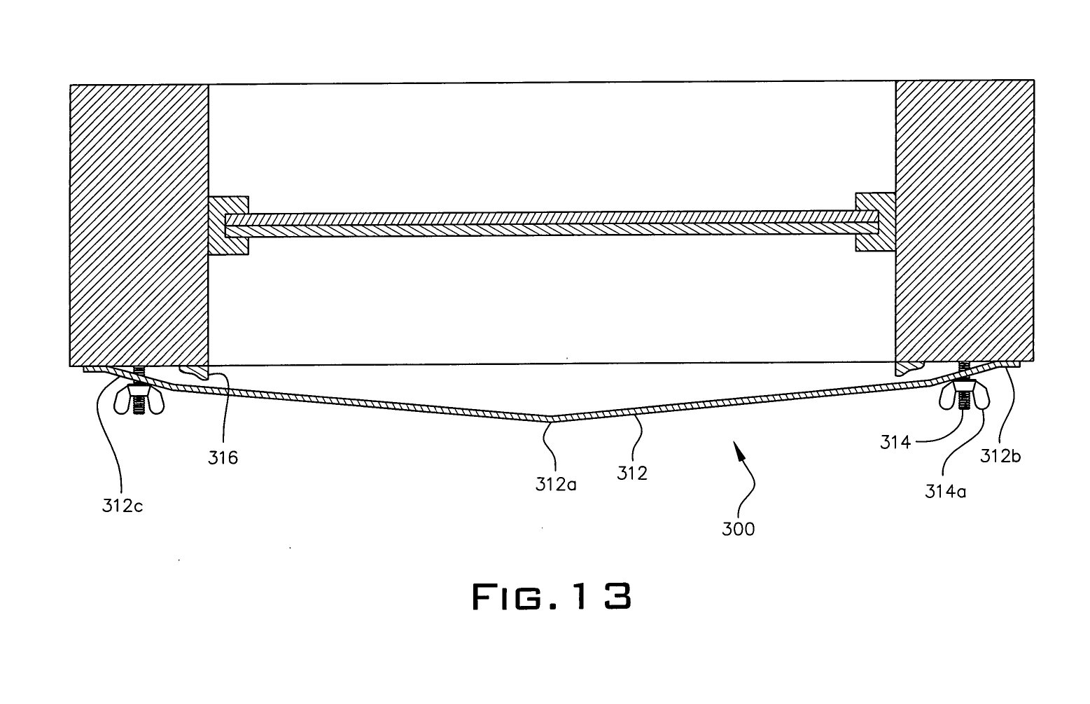

FIG. 14 is a perspective of another embodiment of the invention which is configured to brace and secure a garage door as shown in a bracing position; and

FIG. 15 is a perspective exploded view of the embodiment of FIG. 14.

### DETAILED DESCRIPTION OF THE INVENTION

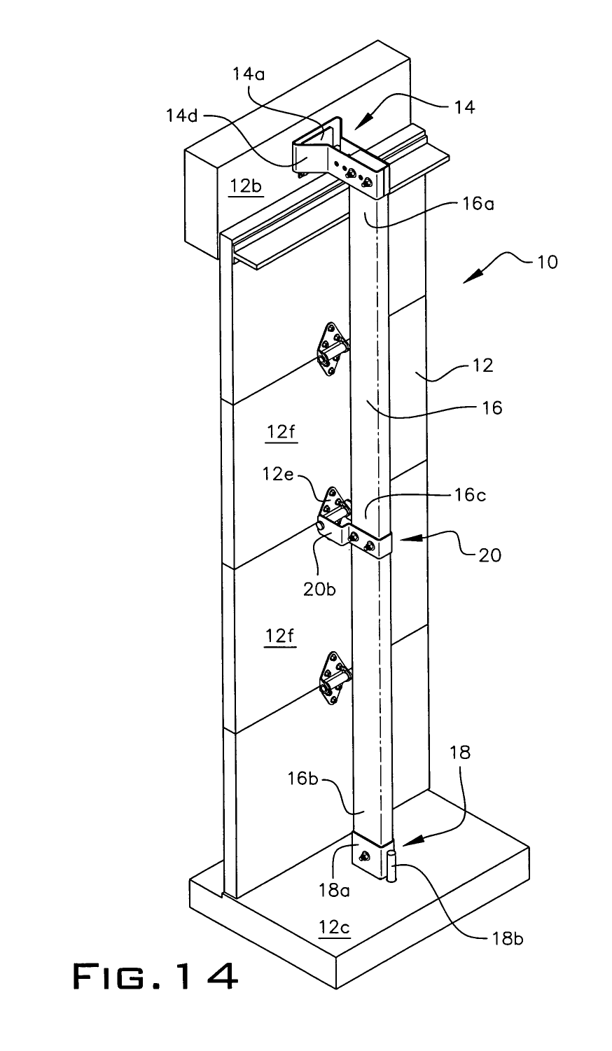

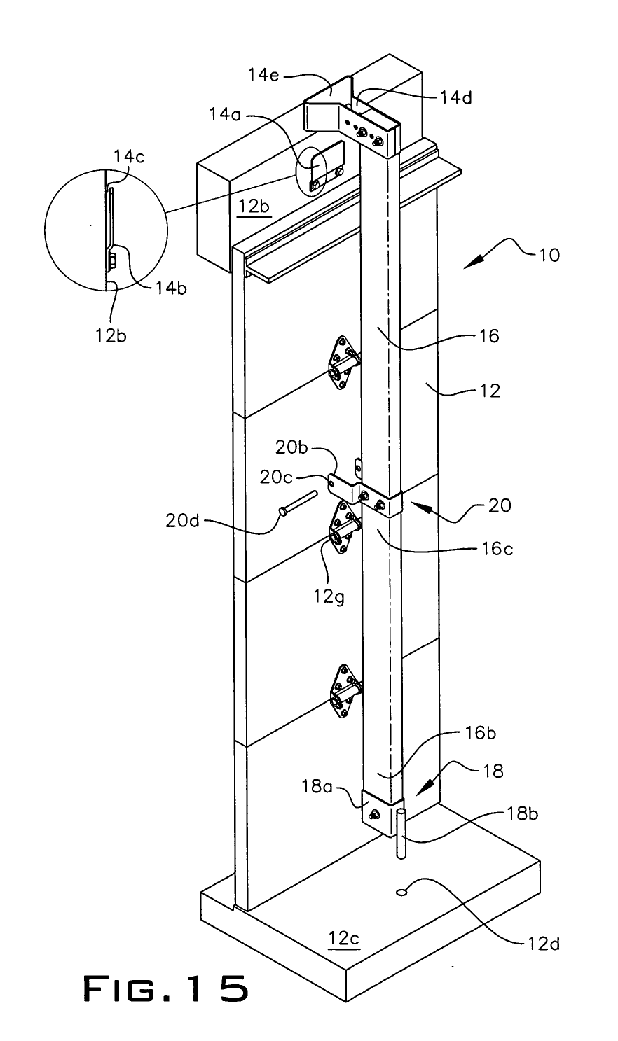

In the embodiment related to the bracing of a garage door, the invention herein and as shown in FIGS. 14 and 15 is a bracket system 10 for use in bracing a garage door 12a for security and for prevention of damage during wind storms, the system comprising first bracket means 14 for bracing an upper end 16a of a vertically oriented elongate structural member 16 to an inside garage surface 12b of a header of a garage door opening; and second bracket means 18 for bracing a bottom end 16b of the vertically oriented elongate structure member 16 to a floor 12c of a garage.

The first bracket means 14 comprises a first bracket portion 14a attachable to the header 12b. The first bracket portion 14a is configured to have an upwardly directed offset 14b to form a gap 14c between the header surface 12b and the first bracket portion 14a wherein a distal end 14e of a second bracket portion 14d projecting from the upper end 16a of the vertically oriented elongate structural member 16 can drop down into said gap 14c to interlock with said first bracket portion 14a. The second bracket portion 14d has one end fixed to the upper end 16a of the vertically oriented elongate structural member 16 and its distal end 14e extending from the vertically oriented elongate structural member 16 a predetermined distance sufficient to drop into and engage the gap 14c formed by the first bracket portion 14a.

The drawings depicted are merely an example of making a bracket that will secure the upper end of structural member 16 to the header surface 12b. The essence of the interlock provision is that the upper end has an appendage that essentially hooks into the gap 14c. Therefore, the second bracket portion can be separately fastened to the member 16 as shown, it can be integral therein, for example if member 16 was made from a polymeric fiberglass reinforced material and if member 16 was metallic, it could be welded thereto.

The second bracket means 18 for bracing the bottom end 16b of the vertically oriented elongate structural member 16 to the floor 12c of the garage comprises a bracket portion 18a fixed to the bottom end 16b of the vertically oriented elongate structural member 16, and a vertically depending elongate member 18b attached to said bracket portion 18a and having a predetermined length sufficient to be dropped into a hole 12d in the garage floor 12c.

Again, this bottom bracket can be fastened as depicted and fabricated from plate material, it can be integral to the member 16 or it can be welded if the member 16 is metallic. The depending elongate member is essential configured to serve as a pin that can be dropped into the hole 12d in the garage floor 12c.

As an option for those end users who desire additional central bracing of the garage door and for additional security as well, the bracket system 10 can include a third bracket means 20 for bracing an intermediate portion 16c of the vertically oriented elongate structural member 16 to a hinge 12e of two adjacent garage door panels 12f. A bracket portion 20a is fixed to the intermediate portion 16c of the vertically oriented elongate structural member 16 and a distal end of said bracket portion 20a extends from the intermediate portion 16c of the vertically oriented elongate structural member 16 and has two parallel vertically oriented sides 20b with apertures 20c therein configured to align with a central aperture 12g of the panel hinge 12e. An elongate retention member 20d of sufficient length and size is insertable through the apertures 20c,12g in the sides 20b and the hinge 12e for interlocking the intermediate portion 16c of the vertically oriented elongate structural member 16 with the garage door hinge 12e. One or more such intermediate bracket to panel hinge devices may optional be used.

Again this third bracket can be made in a number of ways and by way of example of one method, a bracket was made by bending a plate material to engage and fasten to the sides of a structural member 16. The end attaching to the hinge is merely widened or flared out and then straightened out to be slightly wider than the hinge. Apertures are added on the straightened portion at a location so that when placed in position the holes in the bracket will line up with the hole in the hinge so that a retention pin can be inserted.

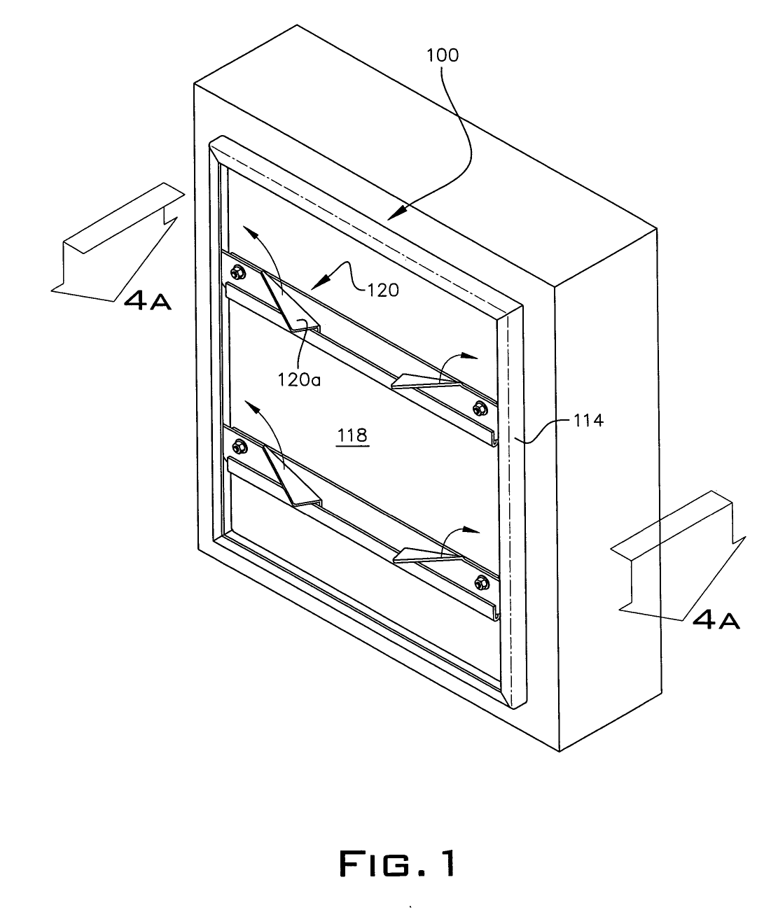

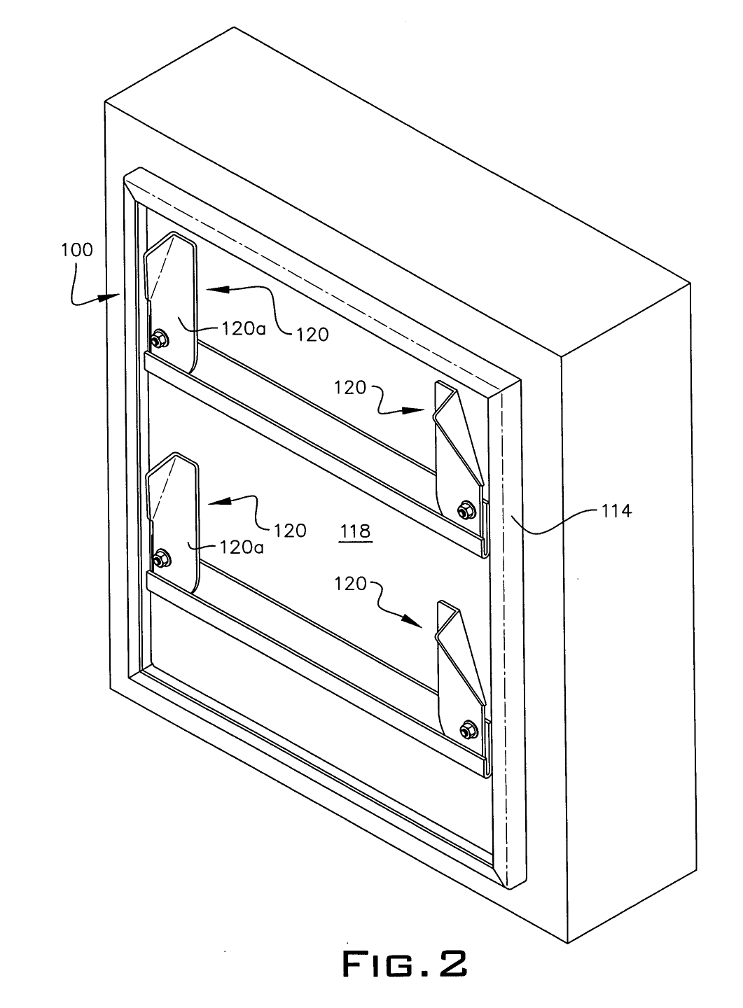

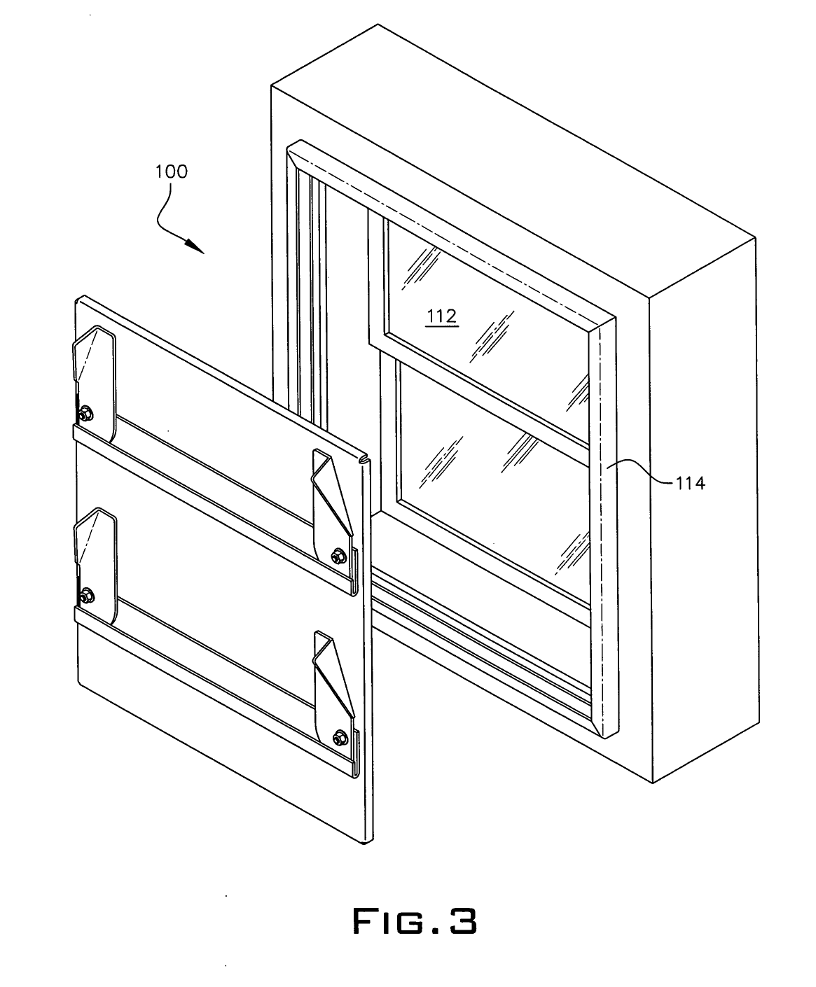

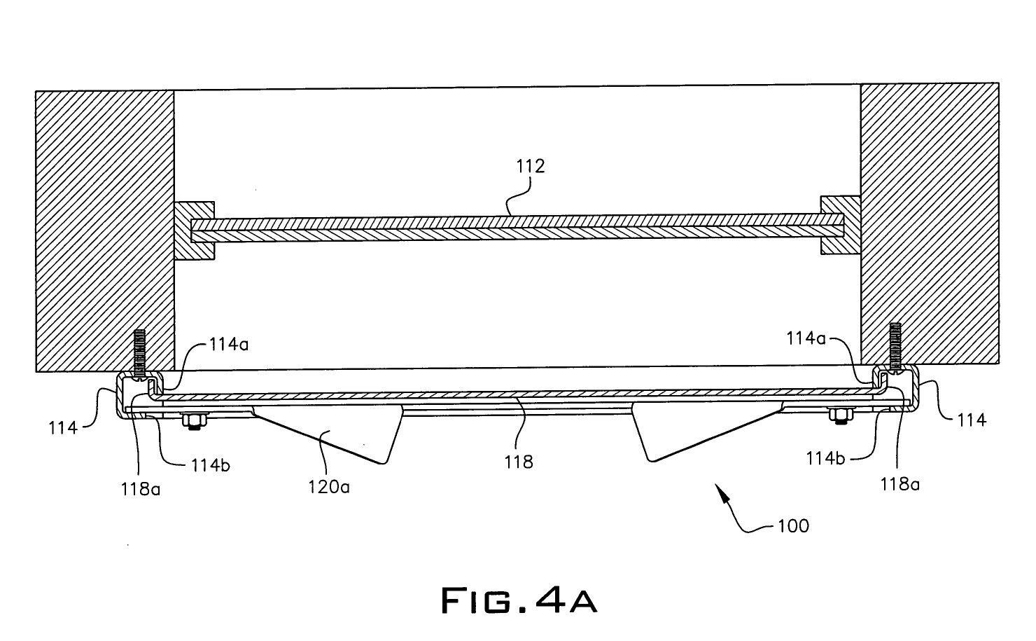

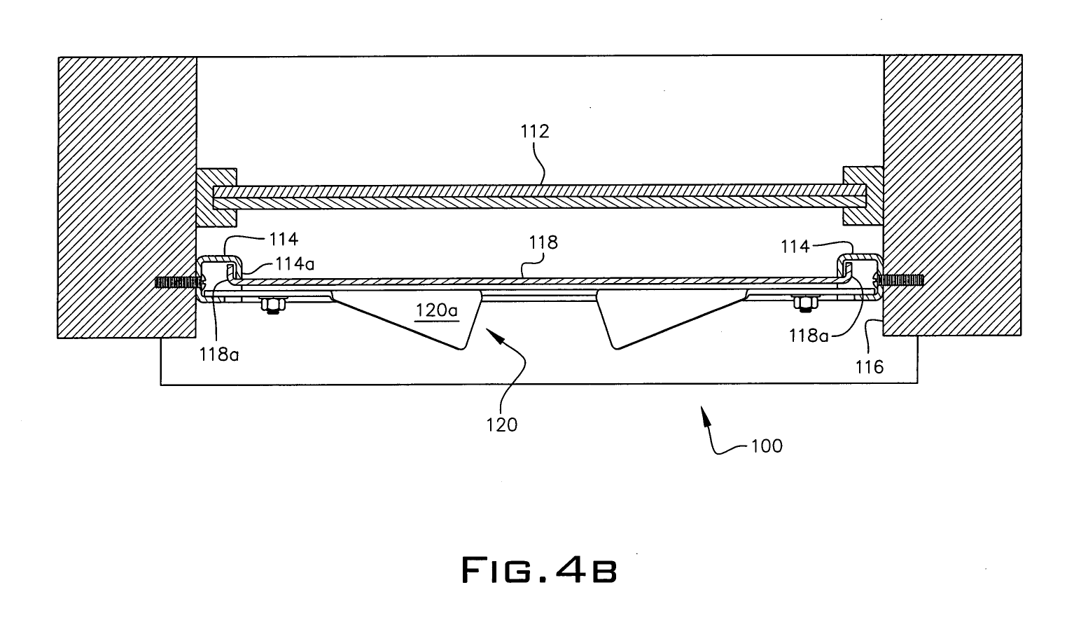

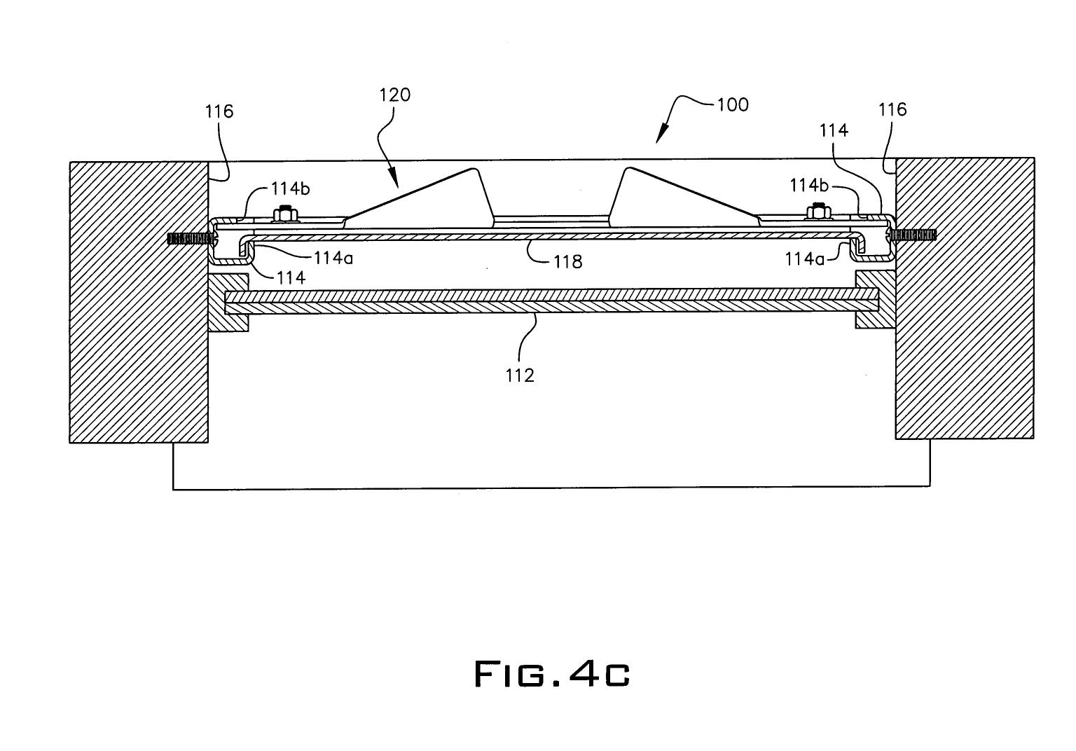

Another storm protection system is a removable storm panel system 100 as shown in FIGS. 1-8 for windows 112. In one of the depicted embodiments, the invention 100 comprises a frame 114 that is mountable to an inside surface of a side wall portion 116 extending from a window 112, the frame 114 being adapted to be installed a predetermined distance from the window glass around a perimeter of the window 112; the frame 114 being formed generally tubular in cross-sectional shape with one side of the tubular shaped frame having a sealing lip portion 114a and an opening 114b for insertion of a storm panel 118, wherein the frame 114 when in use is anchored to the inside surface of the side wall portion 116 with the sealing lip portion 114a directed outwardly; and the storm panel 118 having a bent break portion 118a forming a lip around outer edges of sides of the storm panel 118. The storm panel 118 is sized so that when installed, the bent break portion 118a is inserted in the opening 114b of the frame 114. To secure the panel 118 in place, latching means 120 are providing for interlocking the storm panel 118 with the frame 114 wherein the storm panel 118 is compressed against the sealing lip portion 114a of the frame 114.

The latching means 120 typically comprises two or more pivotable latches 120a attached at desired locations on the storm panel 118 adjacent to the frame 114 such that each latch 120a can be rotated to engage the frame 118 for interlocking therewith. As can be seen in the drawings, one example of such a mechanism is a plate that pivots about a point and one edge/side can be manually rotated about the pivot point such that it is slides into the frame opening. It is preferable that the plate be somewhat offset so that when engaged with the frame, it provides for a relatively snug or tight fit within the frame, thereby forcing the panel outer edge to compress against the raised edge of the lip of the frame. The latching mechanism is preferably reinforced at the area of pivoting; this can simple be done with a reinforcing plate welded to the panel as depicted in the drawings.

It should be understood that other latching means are contemplated such as a simple spring loaded system where latches can slide in position or otherwise engage/disengage with the frame in another acceptable manner depending on the preference of the manufacturer or costs. The drawings herein are only intended to depict an example of one preferred method of latching.

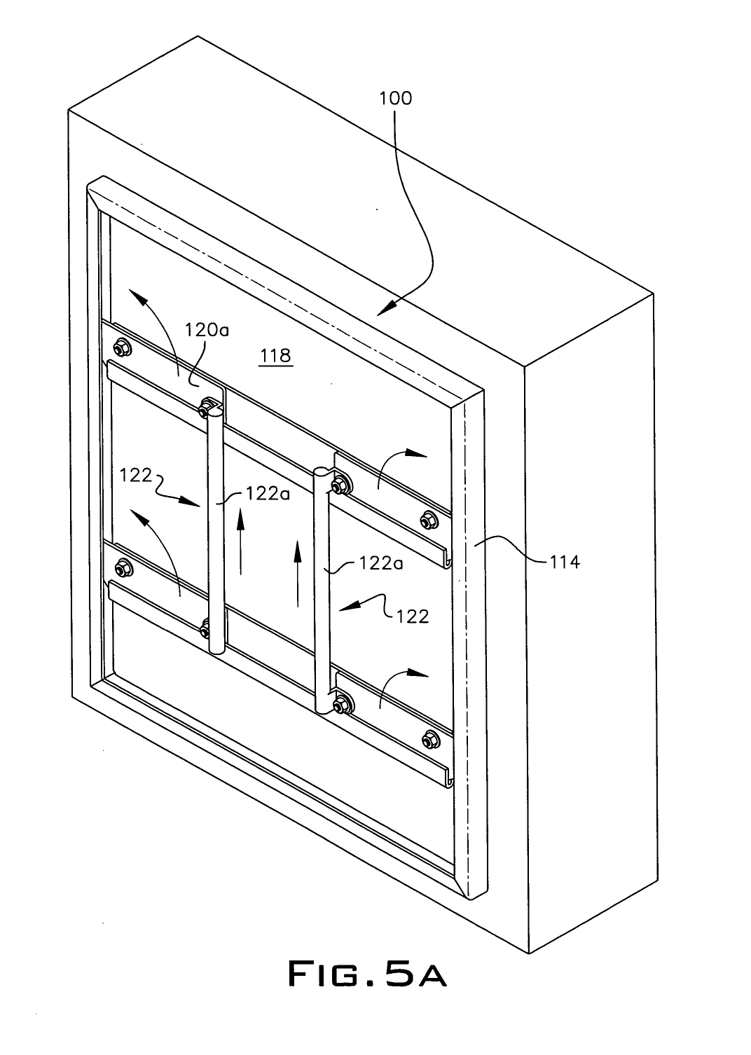

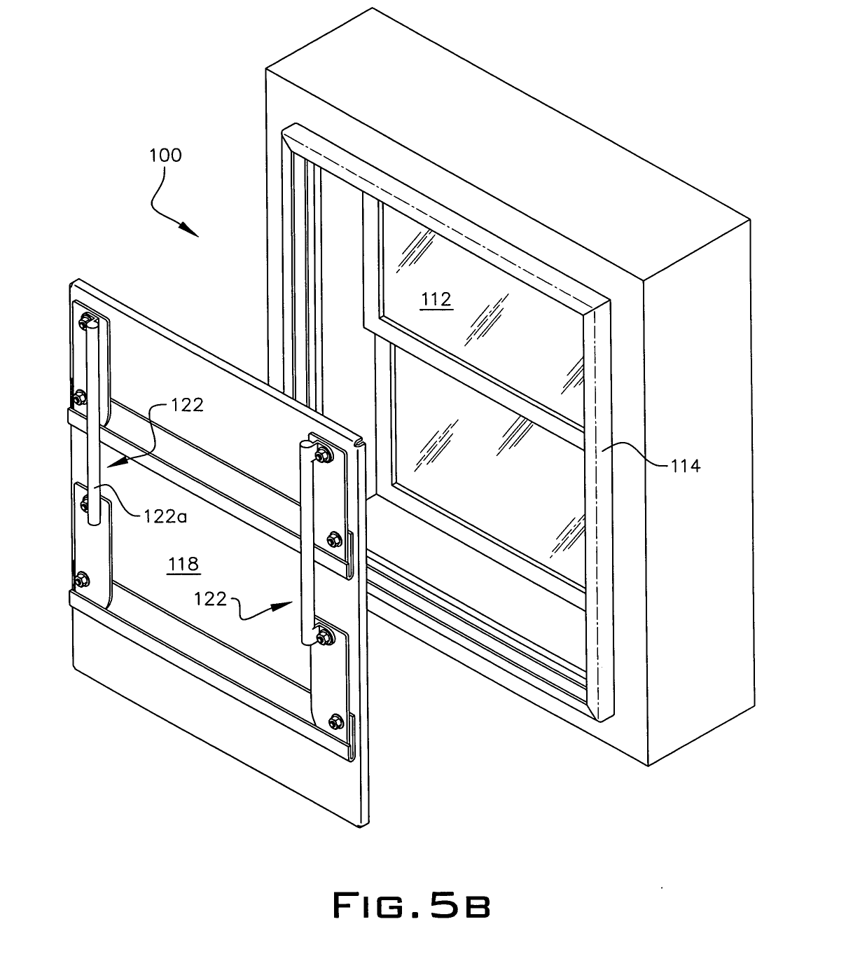

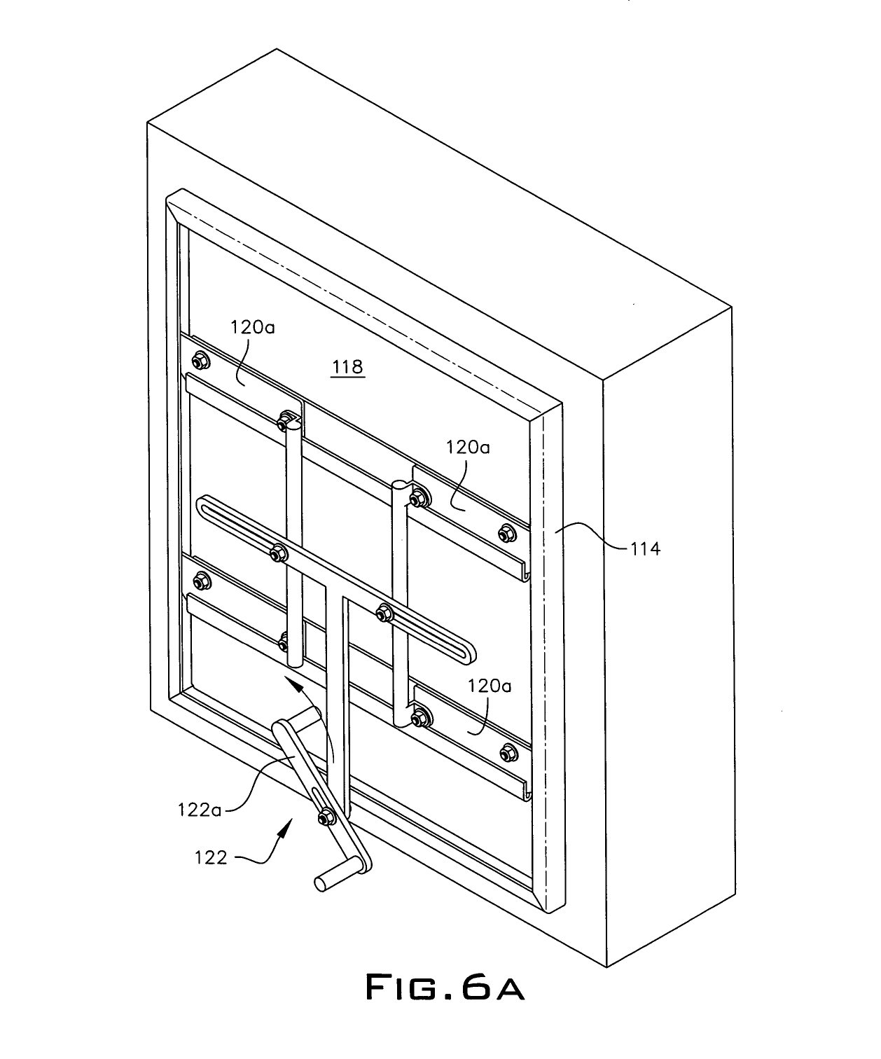

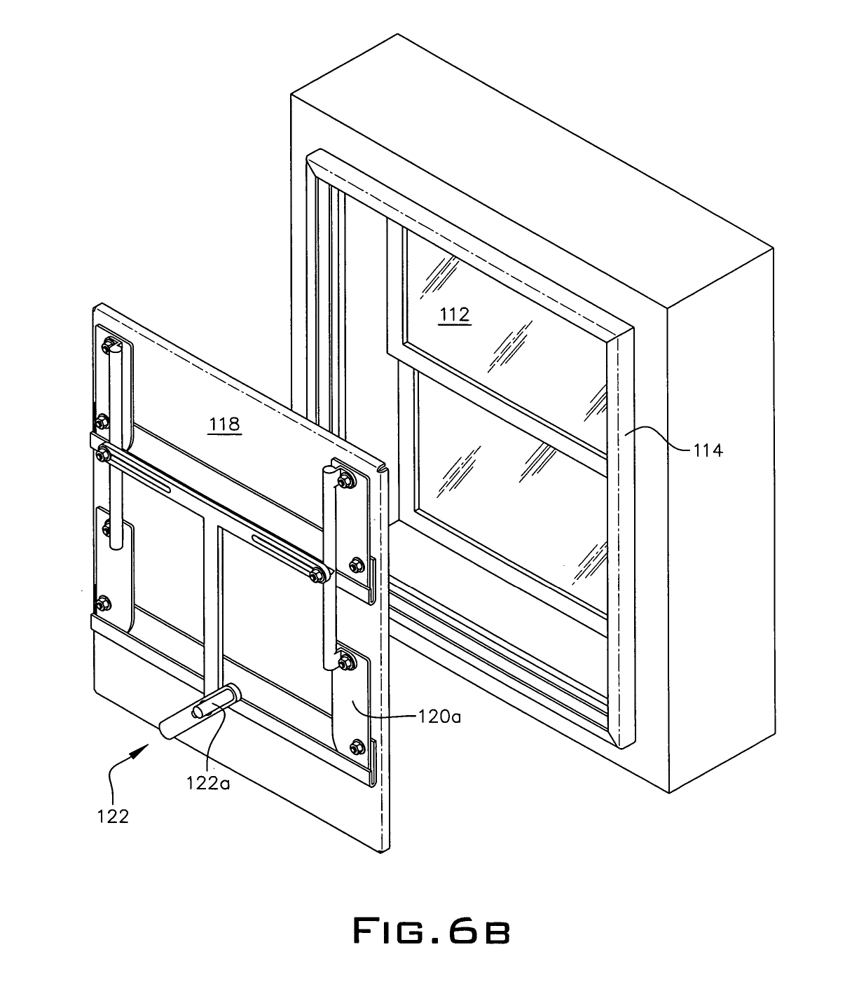

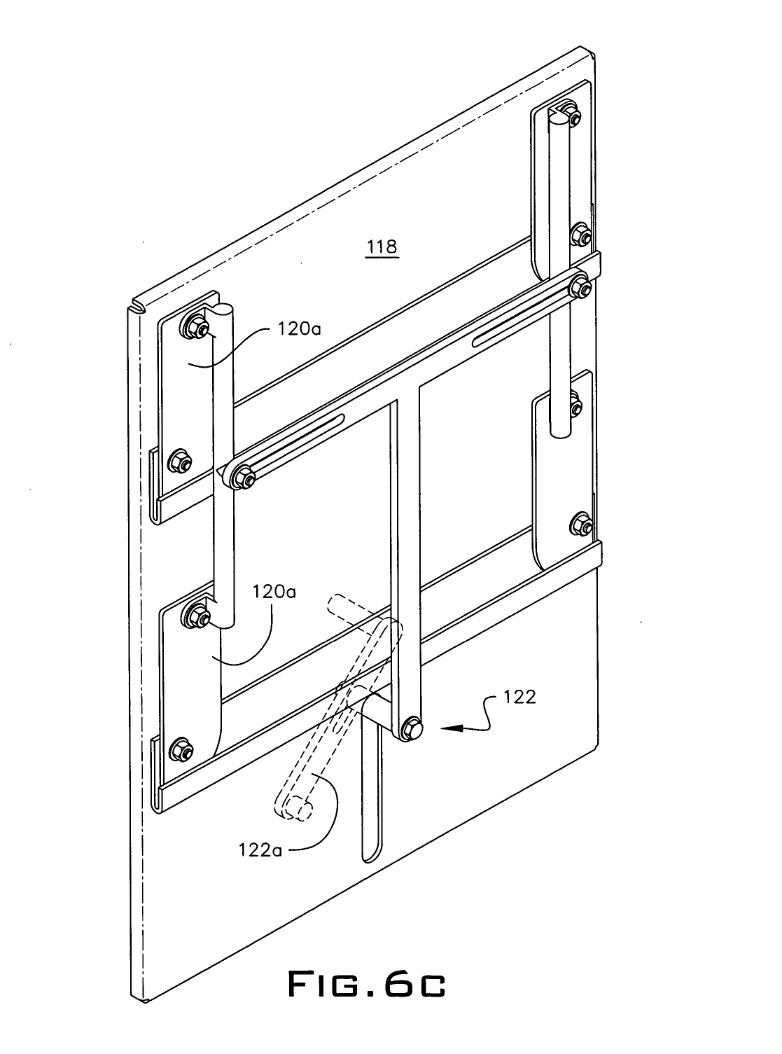

When multiple latches are provided, it may be desirable to have a central location or single mechanism (see FIGS. 5A, 5B, 6A-6C) where all or multiple latches 120a can be operated simultaneously. In such a case, means 122 for controlling each latch 120a for engagement and disengagement with the frame 114 from a single location are provided. The means 122 for controlling each latch 120a from a single location comprises a pivotable handle or central control member or mechanism 122a being in mechanical communication with each of said latches 120a wherein when said handle 122a is partially rotated in one direction, the latches 120a are simultaneously engaged with the frame 114 and when said handle 122a is partially rotated in an opposite direction, the latches 120a are simultaneously disengaged from the frame 114. Although there several ways that one skilled in the art can provide for this feature, one method is as shown conceptually in the drawings where linkages which can serve as a handle or central mechanism 122a in and of itself or where linkages are connected to a central mechanism 122a and connect each latch 120a on a particular side of the storm panel 118 and in turn these latches 120a are controlled by another link to the pivoting handle 122a. As shown in FIG. 6C, the central control mechanism 122 can be located on the opposite side of the latches for operation from inside a house. The depicted manner of doing this is intended to be by way of example only.

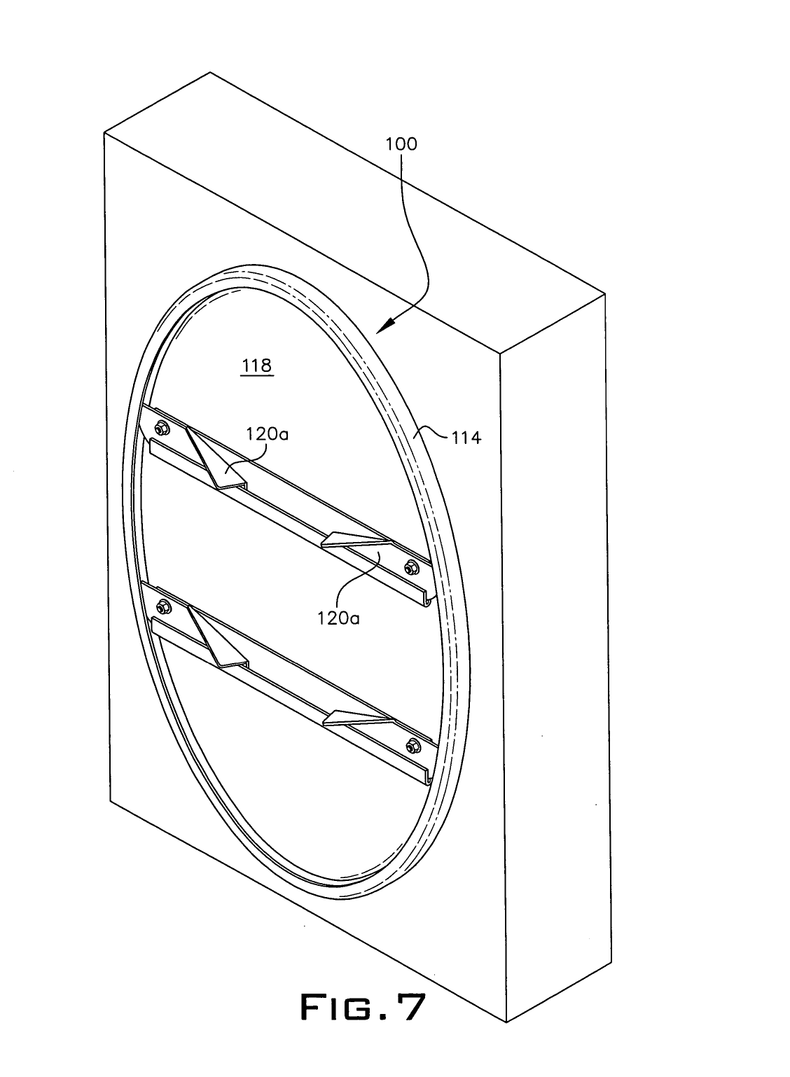

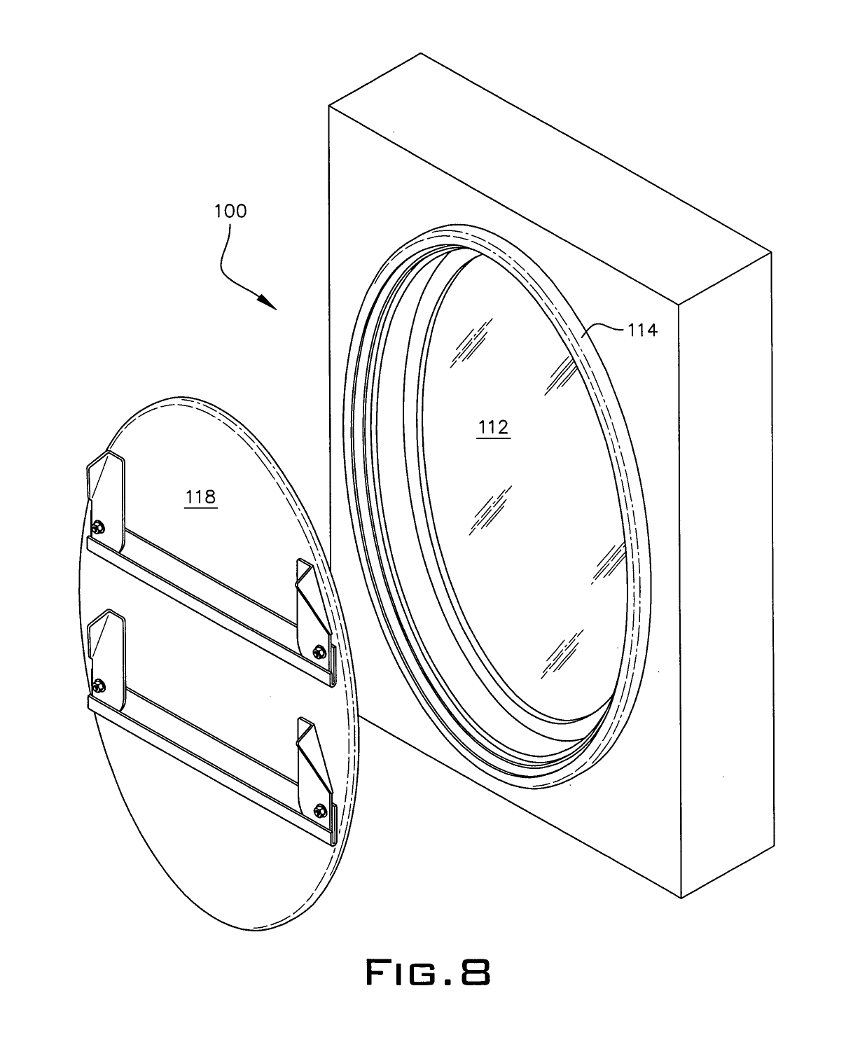

As shown in FIGS. 7 and 8, the invention 100 can be used to protect shaped windows such as a circular-shaped window. The invention 100 can be installed in the interior of the house side to protect the window from inside the house but preferably, the invention in most cases, will be installed on the exterior of the building, either on the exterior wall surface around the window being protected on within the window opening side walls on the exterior side of the window.

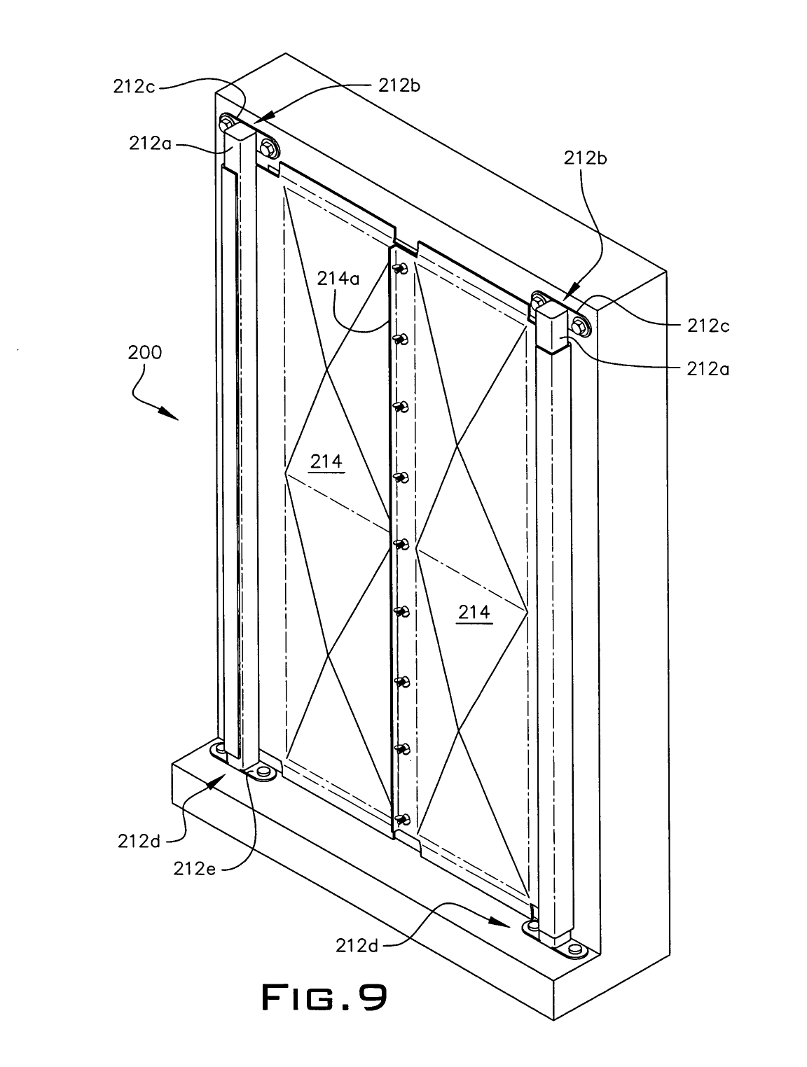

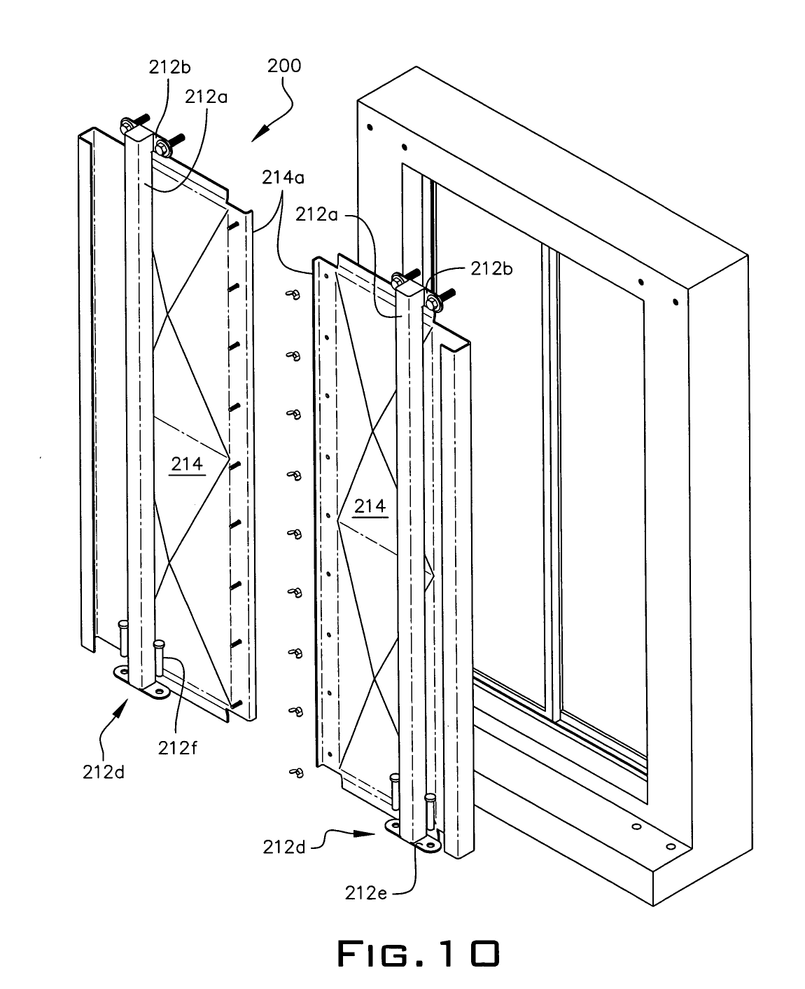

In still another embodiment of the present invention, a removable storm panel system 200, as shown in FIGS. 9 and 10, is provided for prevention of damage during wind storms to sliding glass doors, large door ways or large window areas. The system 200 comprises a longitudinal structural member 212a having a length to extend below and above an area to be protected, an upper bracket 212b configured to be attached to an upper end of the longitudinal structural member 212a, the upper bracket 212b having a flange portion 212c for anchoring said flange portion 212c to a wall surface adjacent the area to be protected. A lower bracket 212d is configured to be attached to a lower end of the longitudinal structural member 212a. The lower bracket 212d has a flange portion 212e for anchoring to a desired part of the building structure adjacent the area to be protected. As shown, the flange portion 212e is oriented horizontally for anchoring to a floor. In this case, a drop in retention pin 212f can be inserted into a predrilled hole (or 2 holes) in the flange and dropped into or fastened to the floor. Of course, another option is that the pin or retention member 212f can be welded or integral to the flange 212e. Although not shown, it is understood that similarly, the flange portion 212e for the lower bracket 212d can be vertically oriented as in the top bracket 212b for anchoring the flange to the wall of the building.

When in use, two longitudinal structural members 212a are typically installed, one on each side of the area to be protected. Two storm panels 214, each configured and sized to cover a portion of the area to be protected are then installed. One side of each storm panel 214 is configured to engage the longitudinal structural member 212a and the storm panel 214 has a width such that an opposing side overlaps an adjoining storm panel 214 by a predetermined distance sufficient to allow for fastening of said overlapping storm panels 214 together. As shown in the drawings, one example of attaching or engaging the storm panel 214 to the longitudinal structural member 212a is to bend the edge of the storm panel 214 to form a cup or C-shaped channel such that it can overlap member 212a.

It is preferred that at least one storm panel 214 further be configured to have a raised bent break portion 214a at an edge of the storm panel 214 overlapping the adjoining storm panel 214 to provide additional rigidity to the storm panels 214 in the overlap area. In the drawings, both storm panels 214 have the bent break portion 214a, although one may be sufficient. In certain counties which have a history of repetitive hurricane strikes, should there be a desire to further reduce any flexure at the center area of the overlapping panels to ensure that the flexing panels spaced-apart by three or four inches from glass does not touch the glass, then additional stiffening can be added by the addition of a flat bar along the bent break portion 214a, such as a ¼ inch thick flat bar stock. This flat bar stock can be fastened or welded to the break portion.

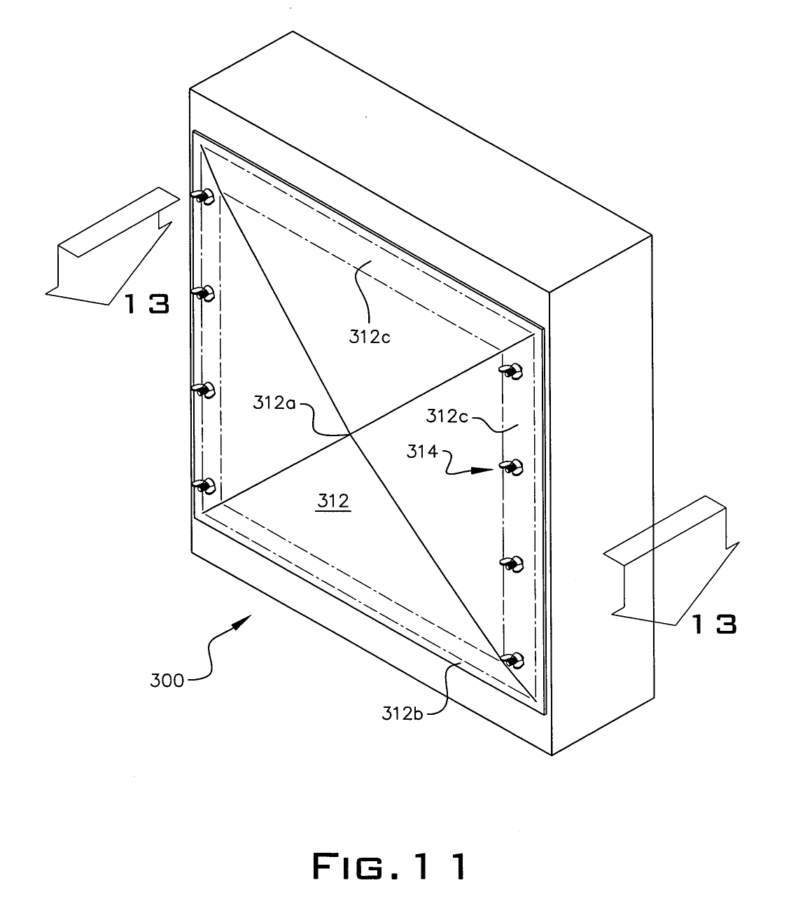

When relatively long window areas need to be protected and it is desired to have more than two panels, one or more intermediate storm panels 214 may be included between the two storm panels 214 attached to the longitudinal structural member 212a. Each intermediate storm panel 214 overlaps a corresponding adjacent storm panel 214 a sufficient distance to allow for the fastening of said adjoining storm panels 214 together. The top and bottom of each panel 214 are preferably configured to have flanged edges similar to those depicted in FIG. 11 herein to serve as a sealing effect against the wall surface above and below the window.

In some cases, a storm panel is needed to cover odd shaped windows, such as windows with brows and circular windows, or windows with outwardly projecting trim or the like, or in areas where the installation of the frame/panel system 100 described above is impractical or not desired by the customer. In most cases such as this, a standard storm panel is needed. However, standard storm panels are typically anchored to the structure along a flat flange area. It is preferred that such an installation include a combination of a nut and a washer. Installing a storm panel when the winds have begun is hard enough, without having to hold onto washers that can easily be dropped. The inventor herein has designed a removable storm panel for a window where the design or configuration itself serves as the washer therefore requiring the use of a nut only. This storm panel system 300 comprises a storm panel 312 configured to be generally bowed 312a and have a flange portion 312b around a perimeter of the storm panel 312 such that the storm panel 312 can be placed over a window area to be protected. The storm panel 312 further has a portion 312c configured to include an angular profile immediately adjacent and inside to the flange portion 312b. The angular profile portion 312c has a plurality of spaced-apart apertures 312d for inserting anchor fasteners 314. A fastening nut 314a can be used without a washer due to a spring locking action provided by the angular profile portion 312c when the fastening nut 314a is tightened against the angular profile portion 312c. This embodiment is very useful when windows have trim or decorative molding 316 around at least a portion of the exterior wall surface of the window. The storm panel 312 can be bowed out sufficiently to clear the trim 316 and allow for the fastening of the panel through the angular profile portion 312c of the storm panel 312.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A removable storm panel system for windows for prevention of damage to windows during wind storms comprising:
a frame adapted to be installed a predetermined distance from a window on a wall surface around a perimeter of the window;
the frame being formed generally tubular in shape with one side of the tubular shaped frame having a sealing lip portion and an opening for insertion of a storm panel, wherein the frame when in use is anchored to the wall surface with the sealing lip portion directed outwardly;
the storm panel having a bent break portion forming a lip around outer edges of sides of the storm panel, the storm panel being sized so that when installed, the bent break portion is inserted in the opening of the frame;
latching means for interlocking the storm panel with the frame wherein the storm panel is compressed against the sealing lip portion of the frame.

2. The removable storm panel system according to claim 1, wherein the latching means for interlocking the storm panel with the frame comprises two or more pivotable latches attached at desired locations on the storm panel adjacent to the frame such that each latch can be rotated to engage the frame for interlocking therewith.

3. The removable storm panel system according to claim 2, further comprising:
means for controlling multiple latches for engagement and disengagement with the frame from a single location.

4. A removable storm panel system for prevention of damage during wind storms to sliding glass doors, large door ways or large window areas comprising:
a longitudinal structural member having a length to extend below and above an area to be protected;
an upper bracket at an upper end of the longitudinal structural member, the upper bracket having a flange portion for anchoring said flange portion to a wall surface adjacent the area to be protected;
a lower bracket at a lower end of the longitudinal structural member, the lower bracket having a flange portion for anchoring said flange portion to a desired part of a building structure adjacent the area to be protected,
wherein when in use, two longitudinal structural members are installed, one on each side of the area to be protected; and
two storm panels, each configured and sized to cover a portion of the area to be protected, one side of each storm panel being configured to engage the longitudinal structural member and the storm panel having a width such that an opposing side overlaps an adjoining storm panel by a predetermined distance sufficient to allow for fastening of said overlapping storm panels together.

5. The removable storm panel system according to claim 4, wherein at least one storm panel further comprises a raised bent break portion at an edge of the storm panel overlapping the adjoining storm panel to provide additional rigidity to the storm panels in the overlap area.

6. The removable storm panel system according to claim 4, further comprising: one or more intermediate storm panels between the two storm panels attached to the longitudinal structural member, each intermediate storm panel overlapping corresponding adjacent storm panels a sufficient distance to allow for the fastening of said adjoining storm panels together.

7. A removable storm panel for a window comprising:
a storm panel configured to be generally bowed and have a flange portion around a perimeter of the storm panel such that the storm panel can be placed over a window area to be protected; and
the storm panel further having a portion configured to include an angular profile immediately adjacent and inside to the flange portion, the angular profile portion having a plurality of spaced-apart apertures for inserting anchor fasteners,
wherein a fastening nut can be used without a washer due to a spring locking action provided by the angular profile when the fastening nut is tightened against the angular profile portion.
